(19) United States
(12) Patent Application Publication
(10) Pub. No.: US 2024/0224932 A1
(43) Pub. Date: Jul. 11, 2024

(54) ANIMAL CARRIER FOR VEHICLES

(71) Applicant: Cynthia Hathcock, Quitman, TX (US)

(72) Inventor: Cynthia Hathcock, Quitman, TX (US)

(21) Appl. No.: 18/402,946

(22) Filed: Jan. 3, 2024

Related U.S. Application Data
(60) Provisional application No. 63/475,516, filed on Jan. 6, 2023.

(51) Int. Cl. A01K 1/02

(52) U.S. Cl. CPC A01K 1/0272

(57) ABSTRACT

This disclosure describes portable carriers configured to secure to a vehicle door window frame. A portable animal carrier may include a carrier portion including a front portion, a rear portion, and side portions extending between the front portion and the rear portion to form an interior at least partially surrounded by the front portion, the rear portion, and the side portions; and legs in parallel with each other, attached to and extending from the carrier portion more proximal to the rear portion than the front portion, wherein the legs slidably engage a vehicle window.

### CROSS-REFERENCE TO RELATED APPLICATION(S)

This application is related to an claims priority under 35 U.S.C. § 119(e) from U.S. Provisional Patent Application No. 63/475,516, filed Jan. 6, 2023, titled “CARRIER FOR DOGS, 3 POUNDS AND UNDER,” the entire content of which is incorporated herein by reference for all purposes.

### TECHNICAL FIELD

Embodiments of the present invention generally relate to a portable animal carrier for a vehicle.

### BACKGROUND

Securing animals in vehicles can be difficult, uncomfortable, and may require using one or more seats of the vehicle.

### SUMMARY

A portable animal carrier may include a carrier portion comprising a front portion, a rear portion, and side portions extending between the front portion and the rear portion to form an interior at least partially surrounded by the front portion, the rear portion, and the side portions; and legs in parallel with each other, attached to and extending from the carrier portion more proximal to the rear portion than the front portion, wherein the legs are configured to slidably engage a vehicle window.

A portable animal carrier may include a carrier portion; and legs in parallel with each other, attached to and extending from the carrier portion, wherein the legs are configured to slidably engage a vehicle window, and wherein the carrier portion is removably attachable to the legs.

A portable carrier may include a carrier portion comprising a front portion, a rear portion, and side portions extending between the front portion and the rear portion to form an interior at least partially surrounded by the front portion, the rear portion, and the side portions; and legs in parallel with each other, attached to and extending from the carrier portion, wherein the legs are configured to slidably engage a vehicle window.

### BRIEF DESCRIPTION OF THE DRAWINGS

FIG. 1 illustrates an example rear view of a vehicle animal carrier in accordance with one embodiment.

FIG. 2 illustrates an example rear perspective view of the vehicle animal carrier of FIG. 1 integrated with a vehicle door window frame in accordance with one embodiment.

FIG. 3 illustrates an example side perspective view of the vehicle animal carrier of FIG. 1 integrated with a vehicle door window frame in accordance with one embodiment.

FIG. 4 illustrates an example front perspective view of the vehicle animal carrier of FIG. 1 in accordance with one embodiment.

FIG. 5 illustrates an example rear perspective view of the vehicle animal carrier of FIG. 1 in accordance with one embodiment.

### DETAILED DESCRIPTION

Aspects of the present disclosure involve an enhanced vehicle carrier for animals.

In one or more embodiments, an animal carrier for smaller animals (e.g., dogs, cats, etc.) may integrate with a vehicle door on the inside of a vehicle. The animal carrier may include legs extending from the carrier and able to slidably engage the window frame of a vehicle door. The legs may be of thin and rigid material (e.g., metal, plastic, etc.) capable of sliding between a vehicle window glass and the vehicle window seal around the vehicle window glass so that the legs may be stabilized inside of the vehicle door (e.g., between the window glass and the window seal). Attachable to the legs may be a carrier portion into which an animal may sit. In this manner, the animal carrier may fit along the inside of a vehicle door without needing to sit on a vehicle seat or use a vehicle seatbelt to be secured.

In one or more embodiments, the dimensions of the carrier portion may vary for different sizes of animals. For example, the length may be from 12-40 inches, the height may be from 4-12 inches, and the depth/width may be from 4-6 inches (e.g., to not extend too far from the door and infringe upon the vehicle seat space). The interior of the carrier may be padded for comfort of the animal.

In one or more embodiments, the carrier may be detachable from the legs to allow for removing the carrier from the vehicle (e.g., for cleaning, transportation, etc.) without needing to remove and reposition the legs in the vehicle window frame. The legs may slidably engage the carrier or may be attached via brackets or other interlocking mechanisms.

The above descriptions are for purposes of illustration and are not meant to be limiting. Numerous other examples, configurations, processes, etc., may exist, some of which are described in greater detail below. Example embodiments will now be described with reference to the accompanying figures.

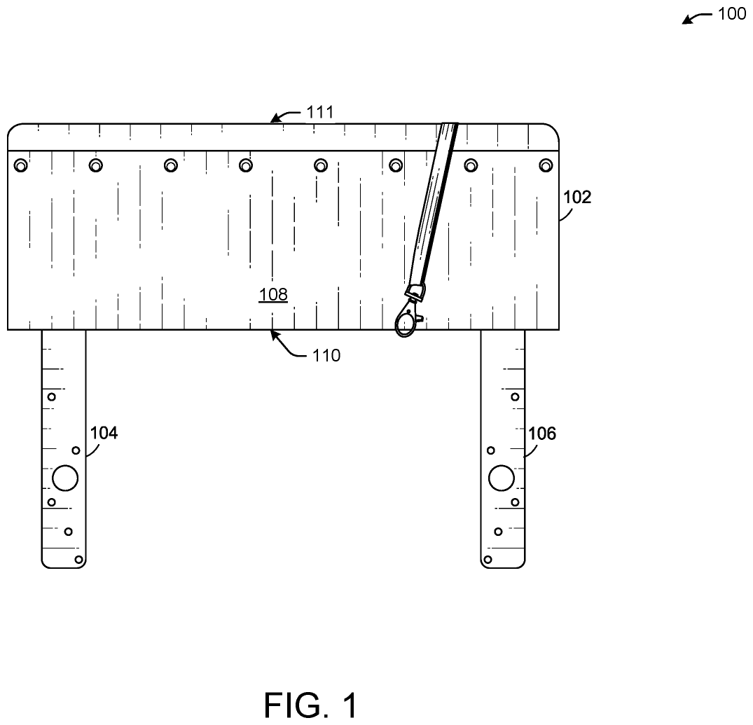

FIG. 1 illustrates an example rear view of a vehicle animal carrier 100 in accordance with one embodiment.

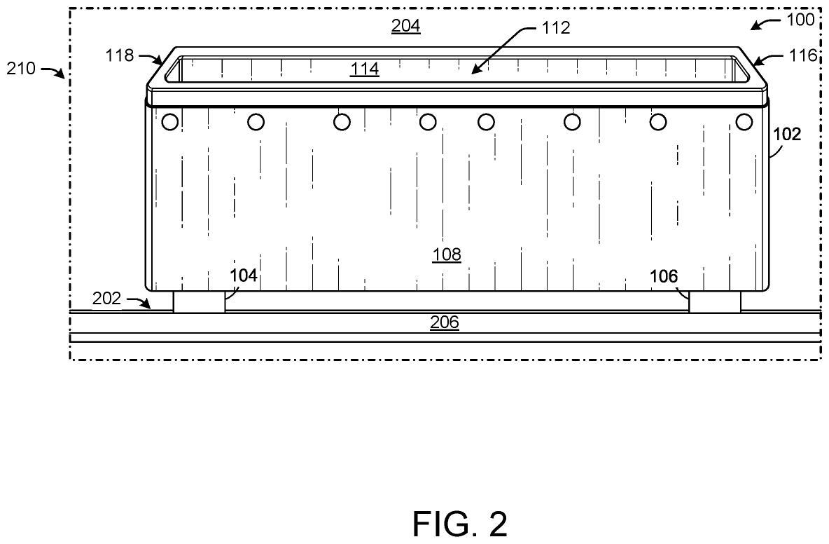

Referring to FIG. 1, the vehicle animal carrier 100 may include a carrier portion 102 into which an animal may sit/lay, and legs 104 and 106 extending from a rear portion 108 of the carrier portion 102, below a bottom surface 110 of the carrier portion 102 so that the carrier portion 102 is above at least a portion of the legs 104 and 106. The legs 104 and 106 may be thin rigid materials. While two legs 104 and 106 are shown, additional legs may be used to support and secure the carrier portion 102 to a vehicle door as shown in FIG. 2. For example, for longer carrier portions 102, there may be additional legs for additional support of the carrier portion 102. The carrier portion 102 may have a top portion 111.

FIG. 2 illustrates an example rear perspective view of the vehicle animal carrier 100 of FIG. 1 integrated with a vehicle door window in accordance with one embodiment.

Referring to FIG. 2, the perspective view of the vehicle animal carrier 100 reveals an interior portion 112 of the vehicle animal carrier 100 into which an animal may sit/lay. The interior portion 112 is formed between the rear portion 108, a front portion 114, and side portions 116 and 118 extending between the front portion 114 and the rear portion 108. The legs 104 and 106 are shown as extending into a window frame between a window seal 202 and a window glass 204. FIG. 2 is shown from the exterior of a vehicle (e.g., exterior of the window glass 204), and on the outside of the window glass 204 is a weather stripping material 206. By extending the legs 104 and 106 in between the window glass 204 and the window seal 202, the carrier portion 102 may be secured along an interior of a vehicle door (e.g., a portion 210 of which is shown in FIG. 2).

In one or more embodiments, by arranging the legs 104 and 106 in parallel with each other and with the rear portion 108, the rear portion 108 may abut the interior of the window glass 204. In this manner, the legs 104 and 106 may be coplanar with the rear portion 108. For example, if the legs were not parallel with one another, they would not both be able to slidably enter the thin space between the window glass 204 and the window seal 202.

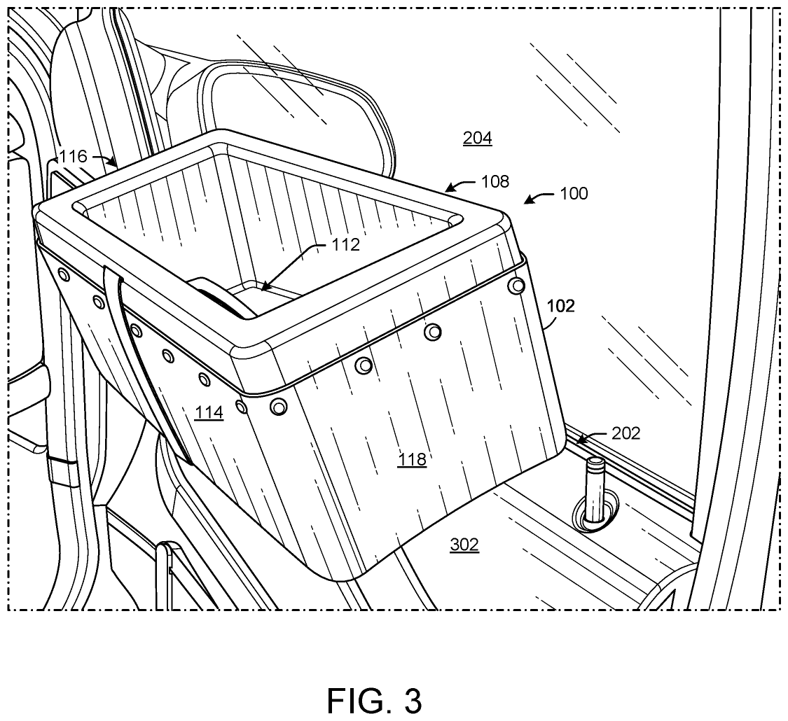

FIG. 3 illustrates an example side perspective view of the vehicle animal carrier 100 of FIG. 1 integrated with a vehicle door window frame in accordance with one embodiment.

Referring to FIG. 3, the vehicle animal carrier 100 is shown positioned within the interior of a vehicle (e.g., inside of the window glass 204). Because the legs 104 and 106 (not shown in FIG. 3 due to the perspective) slide between the window glass 204 and the window seal 202, the carrier portion 102 may be secured along the interior of a vehicle door, which may include a portion 302 onto which at least a portion of the vehicle animal carrier 100 may sit. The vehicle animal carrier 100 may depending on its depth/width, extend further into the interior of the vehicle (e.g., further away from the window glass 204) than the portion 302 of the vehicle door.

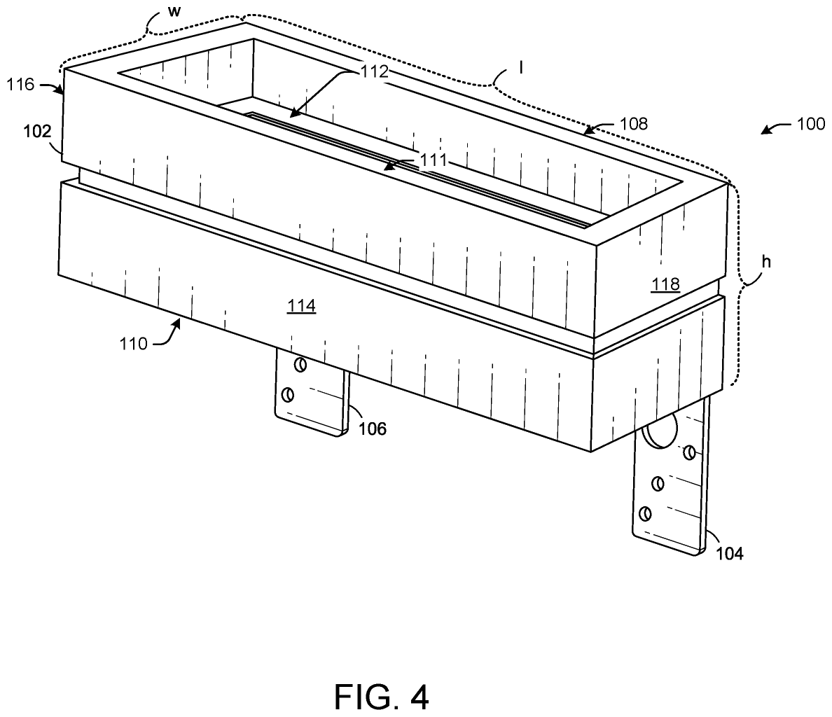

FIG. 4 illustrates an example front perspective view of the vehicle animal carrier 100 of FIG. 1 in accordance with one embodiment.

Referring to FIG. 4, a length l of the carrier portion 102, between the side portion 116 and the side portion 118, may range from 12-40 inches. A height h of the carrier portion 102, from the bottom portion 110 to the top portion 111, may be from 6-20 inches. A depth/width w of the carrier portion 102, from the front portion 114 to the rear portion 108, may be from 6-18 inches.

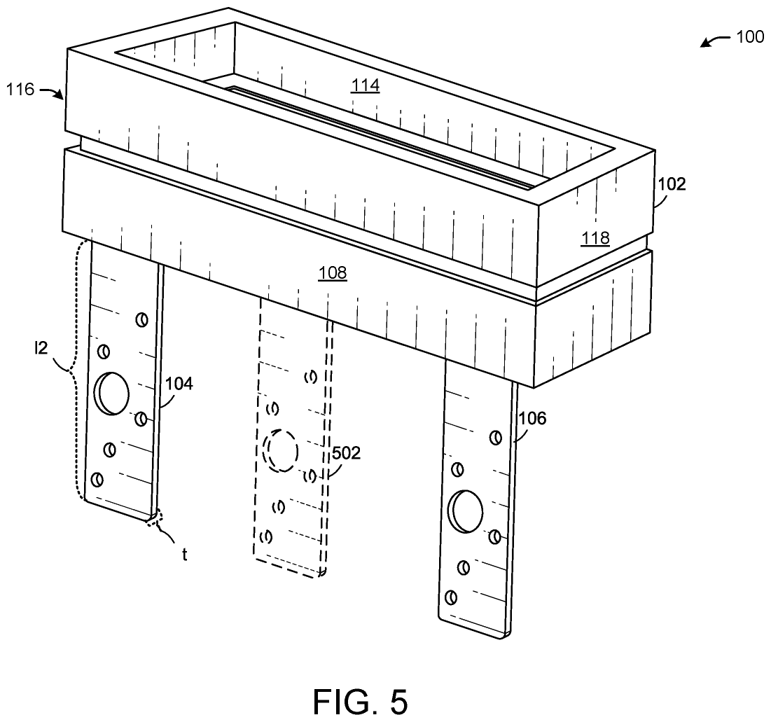

FIG. 5 illustrates an example rear perspective view of the vehicle animal carrier 100 of FIG. 1 in accordance with one embodiment.

Referring to FIG. 5, an optional third leg 502 is shown, and additional legs may be attached to the carrier portion 102. A length l2 of the legs 104, 106, and 502 may be between 6-18 inches to accommodate various vehicle door sizes and sizes and weights of the carrier portion 102 when carrying an animal (e.g., the legs should extend far enough into the vehicle door to support the weight of the carrier portion 102 plus any animals and/or objects placed in the carrier portion 102). A thickness t of the legs may be between 0.125-0.4 inches to allow the legs to fit between the window glass 204 and the window seal 202 (e.g., as shown in FIG. 2).

In one or more embodiments, the legs may include a rigid material such as a metal (e.g., stainless steel, aluminum, brass, tungsten, etc.), ceramics, or plastics.

It is understood that the above descriptions are for purposes of illustration and are not meant to be limiting.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations together with all equivalents thereof.

What is claimed:

1. A portable animal carrier comprising:
a carrier portion comprising a front portion, a rear portion, and side portions extending between the front portion and the rear portion to form an interior at least partially surrounded by the front portion, the rear portion, and the side portions; and
legs in parallel with each other, attached to and extending from the carrier portion more proximal to the rear portion than the front portion,
wherein the legs are configured to slidably engage a vehicle window.

2. The portable animal carrier of claim 1, wherein the legs are attached to the rear portion.

3. The portable animal carrier of claim 1, wherein the legs extend a length of at least six inches from the carrier portion.

4. The portable animal carrier of claim 1, wherein a thickness of the legs is between 0.125-0.4 inches.

5. The portable animal carrier of claim 1, wherein the legs are coplanar with the rear portion.

6. The portable animal carrier of claim 1, wherein the legs comprise a metal, a ceramic, or a plastic.

7. The portable animal carrier of claim 1, wherein a length of the carrier portion is between 12-40 inches, wherein a height of the carrier portion is between 6-20 inches, and wherein a depth of the carrier portion is between 6-18 inches.

8. A portable animal carrier comprising:
a carrier portion; and
legs in parallel with each other, attached to and extending from the carrier portion,
wherein the legs are configured to slidably engage a vehicle window, and
wherein the carrier portion is removably attachable to the legs.

9. The portable animal carrier of claim 8, wherein the carrier portion comprises a front portion, a rear portion, and side portions extending between the front portion and the rear portion to form an interior at least partially surrounded by the front portion, the rear portion, and the side portions, and wherein the legs are attached to the rear portion.

10. The portable animal carrier of claim 9, wherein the legs are coplanar with the rear portion.

11. The portable animal carrier of claim 8, wherein the legs extend a length of at least six inches from the carrier portion.

12. The portable animal carrier of claim 8, wherein a thickness of the legs is between 0.125-0.4 inches.

13. The portable animal carrier of claim 8, wherein the legs comprise a metal, a ceramic, or a plastic.

14. The portable animal carrier of claim 8, wherein a length of the carrier portion is between 12-40 inches, wherein a height of the carrier portion is between 6-20 inches, and wherein a depth of the carrier portion is between 6-18 inches.

15. A portable carrier comprising:
a carrier portion comprising a front portion, a rear portion, and side portions extending between the front portion and the rear portion to form an interior at least partially surrounded by the front portion, the rear portion, and the side portions; and
legs in parallel with each other, attached to and extending from the carrier portion,
wherein the legs are configured to slidably engage a vehicle window.

16. The portable carrier of claim 15, wherein the legs are coplanar with the rear portion.

17. The portable carrier of claim 15, wherein the legs extend a length of at least six inches from the carrier portion.

18. The portable carrier of claim 15, wherein a length of the carrier portion is between 12-40 inches, wherein a height of the carrier portion is between 6-20 inches, and wherein a depth of the carrier portion is between 6-18 inches.

19. The portable carrier of claim 15, wherein the carrier portion is removably attachable to the legs.

20. The portable carrier of claim 15, wherein a thickness of the legs is between 0.125-0.4 inches.
